(19) United States
(12) Patent Application Publication
(10) Pub. No.: US 2014/0046076 A1
(43) Pub. Date: Feb. 13, 2014

(54) Surface Functionalization of a Substrate in an Ionic Liquid Medium

(71) Applicants: Gilles Marchand, Pierre-Chatel (FR); Antoine Hoang, Grenoble (FR); Olivier Zaouak, Ales (FR); Carole Sauer, Grenoble (FR)

(72) Inventors: Gilles Marchand, Pierre-Chatel (FR); Antoine Hoang, Grenoble (FR); Olivier Zaouak, Ales (FR); Carole Sauer, Grenoble (FR)

(21) Appl. No.: 14/003,195

(22) PCT Filed: Mar. 2, 2012
(86) PCT No.: PCT/IB2012/050995

§ 371 Date: Oct. 28, 2013

(30) Foreign Application Priority Data
Mar. 4, 2011 (FR) 1151791

(51) Int. Cl. B05D 1/00

(52) U.S. Cl. CPC B05D 1/00
USPC 549/215; 556/14; 558/110

(57) ABSTRACT

The present invention relates to a process that is useful for surface functionalization of a substrate comprising at least one hydroxyl function, in which one or more point regions of said surface are brought into contact with an ionic liquid matrix containing at least one reactive molecule, as it is known, that carries at least one reactive function, under conditions that are suitable for the creation of a covalent bond between said reactive function of the molecule and a hydroxyl function of said surface.

The present invention relates to a process for the functionalization of a surface of a substrate, in particular of a silicon oxide or metal oxide substrate.

The surface functionalization of a substrate or else material proves to be particularly advantageous for making the surface thus treated suitable for a given application, for instance for forming a stationary phase which is suitable in a chromatography technique, or else a support substrate suitable for grafting biological elements, such as nucleic acids, proteins, etc.

Generally, the functionalization of a substrate of silicon oxide or metal oxide type is carried out via a silanization reaction [1] or via a phosphation reaction involving a phosphonic acid, a phosphonic acid dialkyl ester or a phosphonic acid salt [2]. These processes advantageously make it possible to introduce a chemical function onto these inorganic materials.

Unfortunately, these functionalization processes have the drawback of using solvents, for instance toluene, carbon tetrachloride or trichloroethylene, which are acknowledged to be toxic both to the environment and to the handler. The use of such solvents therefore requires, in addition, on the industrial scale, the use of suitable extraction systems (suction hoods, for example) and retreatment at the industrial level.

Moreover, the functionalization processes usually employed do not enable localized functionalization of the inorganic surfaces treated, in other words control of the localization of the molecules solely in precise regions of the surface of said substrate. However, for some applications, it is advantageous to have a refined localization of the functionalities via the grafted reactive functions. The localization techniques, well known to those skilled in the art, such as photochemistry or electrochemistry generally do not enable, other than certain particular cases where the thickness of the oxide layer is very thin, direct functionalization of oxidized substrates; they only make it possible to locally modify a function grafted previously via conventional functionalization techniques such as silanization or phosphation in toluene.

Finally, the conventional processes of functionalization by silanization or phosphation are not suitable for obtaining several different functionalizations on one and the same given substrate, other than the use, which is often complex, of region-masking processes. However, surface functionalization with various chemical functions can prove to be particularly advantageous for carrying out, for example, selective captures of molecules on various regions of one and the same substrate or else for differently functionalizing a chromatography column in various regions, etc.

Consequently, it would be advantageous to have a new process for the surface functionalization of a substrate, in particular of an inorganic silicon oxide or metal oxide surface, which makes it possible to at least partly overcome the abovementioned drawbacks.

The present invention aims precisely to meet these needs.

More particularly, the present invention relates, according to a first of its aspects, to a process which is of use for the surface functionalization of a substrate, comprising at least the steps consisting in:

(1) providing a substrate which has at least one surface comprising at least one hydroxyl function, and

(2) bringing all or part(s) of said surface into contact with an ionic liquid matrix containing at least one molecule termed reactive, said molecule carrying at least one reactive function capable of interacting with at least one hydroxyl function of the surface, said bringing into contact being carried out under conditions favorable to the creation of a covalent bond between said reactive function of said molecule and a hydroxyl function of said surface.

In particular, the present invention relates to a process which is of use for the surface functionalization of a substrate, comprising at least the steps consisting in:

(1) providing a substrate which has at least one surface comprising at least one hydroxyl function, and

(2) bringing one or more point regions of said surface into contact with an ionic liquid matrix containing at least one molecule termed reactive, said molecule carrying at least one reactive function capable of interacting with at least one hydroxyl function of the surface,

said bringing into contact being carried out under conditions favorable to the creation of a covalent bond between said reactive function of said molecule and a hydroxyl function of said surface.

The term “functionalization” denotes the general reaction consisting in chemically modifying a given surface by means of molecule.

In the context of the present invention the functionalization consists more particularly of covalent grafting, to the surface of said substrate, of one or more molecules termed reactive.

For the purpose of the invention, the term “reactive molecule” is thus intended to denote a molecule carrying at least one reactive function capable of interacting with at least one hydroxyl function of the surface to be functionalized, so as to form a covalent bond.

For the purpose of the invention, the expression “ionic liquid matrix” is also intended to denote a medium which comprises one or more functionalized or nonfunctionalized ionic liquids, and in particular which consists exclusively of one or more ionic liquids, and which is chemically inert.

An “ionic liquid” denotes, generally, a salt or a mixture of salts of which the melting point is below 100° C. [3]. It consists of an organic or inorganic cation and of an inorganic anion. It is known that the physical and chemical properties, in particular in terms of melting temperature, of solubility in a given solvent, of density, of viscosity, of surface tension and of electrical conductivity, depend on the nature both of the cation and of the anion constituting the ionic liquid. The ionic liquids which are particularly preferred for use in the process of the invention are described more precisely below.

Ionic liquids have already been used in many applications.

In particular, the relatively low melting temperature of ionic liquids allows them to be used as solvents for a very large number of syntheses [4], unlike molten salts, such as sodium chloride, the melting temperature of which reaches 801° C. Among the ionic liquids some even have a melting temperature below room temperature; they are known as “Room Temperature Ionic Liquids” (RTILs). Likewise, ionic liquids have the advantage of being able to dissolve a wide range of compounds, such as low-molecular-weight organic compounds, enzymes and polymers [5].

Ionic liquids have, moreover, found numerous applications in the extraction field [6] or the electrochemistry field [7]. More recently, a new class of ionic liquids, “Task Specific Ionic Liquids” (TSILs), has been developed. These TSILs, characterized as ionic liquids carrying one or more chemical functions conferring upon them specific properties, are proposed for various applications, for example in the field of extraction, of catalysis, of organic or asymmetric synthesis, etc.

Mention may also be made of the use of ionic liquids for carrying out the functionalization of glass carbon electrodes with diazonium salts using ionic liquids as solvent under mild conditions, for forming organic layers covalently attached to the surface by means of C-C bonds [8]. Other authors have functionalized carbon based substrates either by thermal decomposition or by electrochemical reduction of TSILs carrying diazonium functions [9], in conventional solvents. Others have immobilized TSILs on silicon oxide surfaces by electrostatic interaction with surface silanols or else by means of silane functions carried by these ionic liquids [10].

Finally, the localized deposition of poly(methyl methacrylate) (PMMA) on silicon oxide using ionic liquids as solvent deposited as drops has been described [11]. In that publication, the authors introduce a polymerization catalyst in a drop of ionic liquid mixed with dimethylformamide. This drop, used as a microreactor, is subsequently deposited on silicon oxide previously functionalized by silanization in toluene, with a silane compound used as initiator. Drops of MMA (methyl methacrylate) monomer are then introduced into the drop and the polymerization begins. At the end of the reaction, a PMMA polymer which is locally deposited, and not covalently bonded to the surface, is obtained.

To the knowledge of the inventors, the functionalization, in particular the localized functionalization, of a surface comprising hydroxyl functions, in particular of a silicon oxide or metal oxide surface by covalent grafting, in an ionic liquid medium of one or more reactive molecules has never been proposed.

The process of the invention proves to be advantageous in several respects.

First of all, it meets the general definition of “green” processes, by using a medium which is not toxic to the environment.

Moreover, the sparingly volatile nature of ionic liquids makes them suitable for use in low volume amounts, in particular in the form of drops. Thus, as subsequently developed, the process of the invention is favorable, according to one particular variant, to the obtaining of localized functionalization of the surface, in other words functionalization limited to one or more specific and predetermined regions of said surface, via more particularly the deposition of the ionic matrix in the form of drops. It is also possible to easily carry out, by means of the process of the invention, different functionalizations with distinct reactive molecules on one and the same surface of a given substrate.

Furthermore, ionic liquids are readily recyclable, and in particular can be easily separated, owing to their low volatility, from any organic compounds.

Finally, ionic liquids, owing to the nature of the anion and/or of the cation of which they are composed, can exhibit good properties in terms of conductivity and thermal stability. By way of example, mention may be made of 1-ethyl-3-methylimidazolium tetrafluoroborate ([EMIM][BF₄]) and 1-ethyl-3-methylimidazolium bis(trifluoromethane)sulfonamide ([EMIM][NTf₂]), which remain stable at respective temperatures of about 300° C. and 400° C. Advantageously, the thermal stability of ionic liquids opens up the possibility of assisting the functionalization reaction of step (2) of the process of the invention, thermally, photochemically, electrochemically or biochemically, in particular by exposure of said surface to a temperature of greater than or equal to 20° C., especially by means of microwaves.

According to one particularly preferred embodiment, the reactive molecule may also comprise at least one secondary reaction unit, which is not reactive with respect to the hydroxyl functions of said surface and is not reactive with respect to said ionic liquid matrix. In fact, such as reaction unit is more particularly chosen from the viewpoint of the application envisioned for the functionalized surface obtained at the end of the process of the invention, for example for the purposes of trapping specific entities precisely characterized in that they are reactive with respect to this secondary reaction unit. Reactive molecules which can be used in the process of the invention are more particularly described below.

Other features, variants and advantages of the process according to the invention will emerge more clearly on reading the description, the examples and the figures which follow, and which are given by way of nonlimiting illustration.

In the remainder of the text, the expressions “between . . . and . . . ”, “ranging from . . . to . . .” and “varying from . . . to . . .” are equivalent and are intended to signify that the limits are inclusive, unless otherwise mentioned.

Unless otherwise mentioned, the expression “containing/comprising a” should be understood as “containing/comprising at least one”.

Surface of the Substrate to be Functionalized

In the context of the present invention, the term “substrate” refers to any solid basic structure having at least one surface comprising one or more hydroxyl function(s).

According to one particular embodiment, the surface is an inorganic surface, in particular of silicon oxide or of metal oxide.

It may more particularly be a surface of silicon oxide or of silicon nitride, previously oxidized according to techniques known to those skilled in the art, of glass, or of metal oxide such as, in particular, of indium tin oxide, of iridium oxide, of titanium oxide, of hafnium oxide, of iron oxide, of copper oxide, of silver oxide or of gallium oxide.

The substrate which has such a surface may itself be an inorganic substrate, in particular a metal oxide or silicon oxide substrate.

According to another particular embodiment, the surface may be an organic surface, of organic polymer type, such as polydimethylsiloxane (PDMS), a plastic, etc. The substrate which has such an organic surface may itself be an organic substrate.

According to another embodiment variant, the substrate may be of any envisionable nature, with the proviso that it has at least one surface comprising hydroxyl functions. For example, the substrate may be coated on at least one of its faces with at least one inorganic layer, in particular of silicon oxide or of metal oxide.

The substrate may be in any possible form from the viewpoint of the application envisioned. It may, for example, be in the form of beads, semi-conductive wafers, etc., and intended for various uses, for example constituting the wall of separative microsystems (also known as “lab-on-chip”), beads of a chromatography column, a microcomponent, etc.

The hydroxyl functions may be naturally present on said surface, or generated prior to step (1) by means of one or more steps for treating the surface of said substrate.

For example, the hydroxyl functions may be generated on a silicon oxide surface by rehydration of said surface according to techniques known to those skilled in the art, for example by immersion in an aqueous-alcoholic solution of sodium hydroxide, by immersion in a solution of H₂O₂ and of H₂SO₄ or else via an oxygen plasma.

Ionic Liquid Matrix

As previously specified, an “ionic liquid matrix” according to the invention comprises a mixture of one or more ionic liquids, which are chemically inert, i.e. which are not reactive with the surface of the substrate and not reactive with the reactive molecules used according to the invention.

According to one particular embodiment, the ionic liquid matrix may comprise, in addition to the ionic liquid(s), one or more secondary solvents, such as hydrophobic solvents, for instance CH₃CN or CH₂Cl₂, or hydrophilic solvents, for instance ethanol. These solvents can be used for the solubilization of the reactive molecule(s), for example silane derivatives, in the ionic liquid(s) used. They can be removed in a step subsequent to the grafting according to the invention.

Generally, ionic liquids are salts or mixtures of salts of which the melting point is below 100° C.

Preferably, the ionic liquid(s) used in the process of the invention is (are) liquid at room temperature; in other words, it (they) has (have) a melting temperature below 25° C.

Of course, the ionic liquid matrix used is completely inert, both with respect to the surface of said substrate to be functionalized and with respect to said reactive molecule(s) used.

The term “inert”, or without distinction “nonreactive”, is intended to mean that the ionic liquid matrix does not react or interact or does not induce any reaction with the surface to be functionalized and the reactive molecules used.

The ionic liquids are composed of an organic or inorganic cation and of an inorganic anion.

According to one particular embodiment, the ionic liquid matrix used in the process of the invention comprises one or more ionic liquid(s) of which the cation is chosen from imidazolium, pyridinium, pyrrolidinium, ammonium, phosphonium and sulfonium cations.

Preferably, the ionic liquid(s) used according to the invention has (have) a cation chosen from imidazolium, pyrrolidinium and ammonium cations, preferably an imidazolium cation and more preferentially a 1-ethyl-3-methylimidazolium cation.

The ionic liquid(s) used in the process of the invention can have an anion chosen from BF₄⁻, Al₂Cl₇⁻, Al₃Cl₁₀⁻, Au₂Cl₇, Fe₂Cl₇⁻, AlCl₄⁻, FeCl₄⁻, SbF₆⁻, ZnCl₃⁻, NO₃⁻, PF₆⁻, N(CF₃SO₂)₂⁻, CF₃CO₂⁻, CH₃SO₃⁻, RCO₂⁻, RSO₃⁻, Cl⁻, Br⁻, CF₃SO₃⁻, RSO₄⁻, halides, TfO⁻ (triflate) and FAP (trifluorophosphate)anions.

Preferably, the ionic liquid(s) used has (have) an anion chosen from bis(trifluoromethane)sulfonamide (NTf₂), hexafluorophosphate (PF₆), tetrafluoroborate (BF₄) and trifluoromethanesulfonate (TfO) anions, and more preferentially bis(trifluoromethane)sulfonamide (NTf₂).

According to one particularly preferred embodiment, the ionic liquid(s) used in the process of the invention has (have) a cation chosen from the abovementioned cations and an anion chosen from the abovementioned anions.

According to one particular embodiment, the ionic liquid matrix is made up of a single ionic liquid.

According to one particularly preferred embodiment, the ionic liquid matrix comprises one or more ionic liquids chosen from:
1-ethyl-3-methylimidazolium bis(trifluoromethane)sulfonamide [EMIM][NTf₂];
1-butyl-1-methylpyrrolidinium bis(trifluoromethane)sulfonamide [BMP][NTf₂];
trimethylbutylammonium bis(trifluoromethane)sulfonamide [TMBA][NTf₂];
1-butyl-3-methylimidazolium hexafluorophosphate [BMIM][PF₆];
1-butyl-3-methylimidazolium tetrafluoroborate [BMIM][BF₄]; and
1-ethyl-3-methylimidazolium trifluoromethanesulfonate [EMIM][TfO].

According to one particular embodiment, the ionic liquid matrix comprises no compound other than the abovementioned ionic liquid(s).

According to one particularly preferred embodiment, the ionic matrix used in the process of the invention comprises at least the compound 1-ethyl-3-methylimidazolium bis(trifluoromethane)sulfonamide [EMIM][NTf₂].

Reactive Molecule

The process of the invention uses, in step (2) thereof, one or more molecule(s) termed reactive.

The reactive molecule according to the invention carries at least one reactive function capable of interacting with at least one hydroxyl function of the surface to be functionalized. More particularly, the reactive function carried by said reactive molecule and a hydroxyl function of the surface interacts so as to form a covalent bond.

According to one particular embodiment, the interaction between the reactive function of said reactive molecule and a hydroxyl function of the surface of said substrate is a silanization or phosphation reaction. The term “phosphation” is intended to mean the grafting of phosphonic acid dialkyl esters, of phosphonic acids or of phosphonic acid salts.

More particularly, the reactive function of the reactive molecule used in step (2) of the process of the invention can be represented by a group of formula:

(R₁R₂R₃)Si—

in which R₁, R₂ and R₃ are chosen, independently of one another, from halogen atoms, linear or branched C₁ to C₄ alkoxy groups and linear or branched C₁ to C₄ alkyl groups, with at least one of R₁, R₂ and R₃ being a halogen atom or a linear or branched C₁ to C₄ alkoxy group, in particular a methoxy or ethoxy group;

or of formula:

(R₄)(R₅)P(O)—

in which:
R₄ and R₅ are chosen, independently of one another, from linear or branched C₁ to C₄ alkoxy groups, in particular from ethoxy and methoxy groups; or

R₄ and R₅ both represent a hydroxyl group; or

R₄ and R₅ both represent an —O⁻M⁺ group, in which M represents sodium, potassium or an ammonium group.

As mentioned previously, said reactive molecule(s) may comprise a secondary reaction unit which is inert both with respect to said hydroxyl functions of the surface and with respect to said ionic liquid matrix.

This inertness may be natural or may have been conditioned via the neutralization of said unit with a protective group, such as, for example, a BOC group. At the end of the functionalization reaction, this inertness will then be removed via the deprotection of the unit.

In other words, at the end of step (2) of the process of the invention, a free reaction unit at the surface of said substrate exists or is capable of being generated at said surface.

According to one particularly preferred embodiment, said reactive molecule(s) is (are) chosen from silane derivatives of formula (I) described above and/or phosphonic acid derivatives of formula (II) described above.

According to a first embodiment variant, said reactive molecule(s) is (are) chosen from the silane derivatives of formula (I) below:

(R₁R₂R₃)Si—R—(F) (I),

in which:
R₁, R₂ and R₃ are chosen, independently of one another, from halogen atoms, linear or branched C₁ to C₄ alkoxy groups and linear or branched C₁ to C₄ alkyl groups, with at least one of R₁, R₂ and R₃ being a halogen atom or a linear or branched C₁ to C₄ alkoxy group, in particular a methoxy or ethoxy group, preferably all three of R₁, R₂ and R₃ are chosen from halogen atoms and linear or branched C₁ to C₄ alkoxy groups, in particular methoxy and ethoxy groups;
R is a linear or branched alkyl chain, having from 1 to 100 carbon atoms, optionally comprising one or more heteroatoms, in particular chosen from O, N and S, and optionally one or more aryl groups; and
F is a chemical function which is inert with respect to said ionic liquid matrix and to the hydroxyl functions of said surface, and capable of interacting or reacting with a chemical, biochemical or biological molecule. F may optionally be protected with a labile protective group.

According to another embodiment variant, said reactive molecule(s) is (are) chosen from the phosphonic acid derivatives of formula (II) below:

(R₄)(R₅)P(O)—R—F (II),

in which:
R₄ and R₅ are chosen, independently of one another, from linear or branched C₁ to C₄ alkoxy groups, in particular from ethoxy and methoxy groups; or

R₄ and R₅ both represent a hydroxyl group; or

R₄ and R₅ both represent an —O⁻M⁺ group, in which M represents sodium, potassium or an ammonium group;
R is a linear or branched alkyl chain, having from 1 to 100 carbon atoms, optionally comprising one or more heteroatoms, in particular chosen from O, N and S, and optionally one or more aryl groups; and
F is a chemical function which is inert with respect to said ionic liquid matrix and to said hydroxyl functions of the surface, and capable of interacting or reacting with a chemical, biochemical or biological molecule. F may optionally be protected with a labile protective group.

According to one particularly preferred embodiment, in the case of the implementation of a phosphation reaction, said reactive molecule(s) (are) advantageously phosphonic acid salt derivatives, in particular of abovementioned formula (II), in which R₄ and R₅ both represent an —O⁻M⁺ group, in which M represents sodium, potassium or an ammonium group, in particular sodium.

These phosphonic acid salt derivatives are particularly advantageous from the viewpoint of their stability during the implementation of the process of the invention and of their greater compatibility with the function F.

According to one particular embodiment, the function F in the abovementioned formulae (I) and (II) can be chosen from electrophilic chemical functions, in particular carbonyl functions, for instance carboxylic acid, activated ester, acyl chloride, ketone or aldehyde functions, halogenated functions, unsaturated functions, for instance double or triple bond functions, maleimide functions; nucleophilic chemical functions, in particular amines, hydroxyls, thiols, oxyamines, azides, hydrazides; and inert chemical functions, in particular alkyls and aryls.

By way of examples of a reactive molecule according to the invention, capable of interacting with a hydroxyl function, mention may be made of 5,6-epoxyhexyltriethoxysilane and 6-phosphonohexanoic acid.

Of course, the nature of the reactive molecule used, in particular of the secondary reaction unit that it optionally comprises, is chosen from the view point of the application envisioned for the functionalized surface obtained at the end of the process of the invention.

Functionalization of the Surface

As previously specified, the process of the invention comprises bringing all or part(s) of the surface to be functionalized into contact with an ionic liquid matrix, in particular as previously described, containing at least one reactive molecule as previously described.

Several implementation variants of the process of the invention can be envisioned.

Thus, according to a first embodiment variant, step (2) may comprise, consecutively, (a) bringing all or part(s) of said surface, in particular of one or more point regions of said surface, into contact with an ionic liquid matrix devoid of reactive molecule, and (b) adding said reactive molecule(s) to said ionic liquid matrix.

According to another embodiment variant, the mixture of an ionic liquid matrix devoid of reactive molecule and of said reactive molecule(s) may be formed prior to the implementation of step (2).

The functionalization carried out according to the process of the invention may be performed on all or part(s) of the surface to be functionalized.

In fact, according to a first particular embodiment, the functionalization may be performed on the whole of said surface. In the context of this embodiment, step (2) may then comprise bringing all of said surface into contact with said ionic liquid matrix, in particular by immersion of said surface, or even of said substrate, in the ionic liquid matrix.

As previously presented, the surface to be functionalized may be immersed in an ionic liquid matrix devoid of reactive molecule, said reactive molecule(s) being subsequently introduced into the ionic liquid matrix.

Alternatively, the surface to be functionalized may be immersed in an ionic liquid matrix already comprising said reactive molecule(s).

According to another particular embodiment, the process of the invention advantageously allows localized functionalization. The bringing into contact with said ionic liquid matrix in step (2) may thus be limited to one or more point regions of said surface.

More particularly, the localized bringing into contact may be carried out via the deposition of drops of said ionic liquid matrix on one or more predetermined regions of the surface.

The term “drop” is intended to mean any volume of ionic liquid of less than 20 μl. Such drops can be deposited at the surface of said substrate using techniques known to those skilled in the art. For example, the drop can be formed using an automated dispensing device, a manual pipette or a screen printing tool.

According to one embodiment variant, a drop of an ionic liquid matrix can be deposited at the surface of each of the regions to be functionalized, then said reactive molecule(s) is (are) subsequently introduced into the drop, for example using a syringe, an automated dispensing device, a manual pipette, etc.

Alternatively, the localized bringing into contact consists of the deposition of drops of the ionic liquid matrix already comprising said reactive molecule(s).

According to one particular embodiment, step (2) uses two distinct reactive molecules formulated, respectively, in two distinct ionic matrices, each of the two matrices being deposited in the form of drops at the surface of at least two distinct point regions of said surface. Of course, the process of the invention may use more than two different reactive molecules, from the viewpoint of the desired functionalization.

The process of the invention can thus make it possible to easily carry out several different functionalizations at the surface of a given substrate, without requiring complex techniques such as region-masking techniques.

According to one particular embodiment, step (2) is carried out at room temperature, i.e. from 20 to 25° C.

According to another embodiment, the interaction in step (2) between the reactive function of said molecule and a hydroxyl function of the surface can be thermally assisted, for example by means of heat supply of water bath type or of microwaves or of ultrasound, photochemically assisted, electrochemically assisted or biochemically assisted, for example by means of an enzyme.

According to one particularly preferred embodiment, the interaction in step (2) between the reactive function of said molecule and a hydroxyl function of the surface is thermally assisted by means of microwaves, more particularly by exposure of said treated surface to a temperature of greater than or equal to 20° C., in particular ranging from 30 to 200° C.

The time during which the ionic liquid matrix is brought into contact with said surface, at room temperature or with exposure to a temperature of greater than or equal to 20° C., also called “incubation time”, can range from a few minutes to 24 hours, for example from 10 minutes to 16 hours.

At the end of step (2) of the process of the invention one or more steps of removing the ionic liquid matrix, of washing the functionalized surface and/or of drying the functionalized surface can be performed.

For example, the treated surface can be washed with a solution of ethanol, and then optionally subjected to ultrasound in a solution of ethanol. The washing step can be followed by drying under nitrogen, optionally followed by a step of heating in a stove, in particular at a temperature of from 100 to 150° C., especially for a period of from 1 to 4 hours.

The process of the invention results in the covalent grafting of one or more reactive molecules onto said substrate.

Such locally or non-locally functionalized surfaces can be used in many applications, from the viewpoint of said grafted reactive molecule(s).

As previously seen, said reactive molecule(s) may also comprise one or more secondary reaction units which are not reactive with respect to said hydroxyl functions of the surface and not reactive with respect to said ionic liquid matrix, for instance a function F as carried by the molecules of formulae (I) and (II) previously described.

When the reaction unit(s) is (are) protected with a protective group as previously mentioned, one or more steps aimed at protecting these reaction units can be performed at the end of step (2) of the process of the invention, or at the end of the optional steps, previously mentioned, of removing the ionic matrix, of washing and/or of drying.

The substrates thus functionalized at the end of the process of the invention can have many applications.

According to a first embodiment variant, the reaction units present at the surface of said substrate at the end of the process of the invention can be used as they are, without subsequent modification other than optional deprotection. By way of example, the process can enable the functionalization of silica beads with silanes carrying reaction units representing hydrophobic groups, in particular long hydrophobic hydrocarbon-based chains, for example octadecyl (C₁₈) groups. These silica beads, exhibiting a hydrophobic surface, can be used as a stationary phase for reverse-phase chromatography. It is also possible to functionalize lab-on-chip wall surfaces or glass slide surfaces.

According to another embodiment variant, the reaction units can be subsequently modified, for example by reaction or interaction with a chemical, biochemical or biological molecule. Reference is made to “on support” chemical, biochemical or biological reactions. By way of example, the treated surface can exhibit, at the end of the process of the invention, reaction units provided by the grafted molecules, conducive to the subsequent grafting of biological elements, for example nucleic acids, proteins, sugars, etc. It is, for example, particularly advantageous to have substrates which exhibit grafted bioactive molecules that give them specific properties, such as cytotoxic properties, in particular antibiotic, bactericidal, virucidal and/or fungicidal properties. Such surface-treated substrates have many applications, in particular in the medical or diagnostic field, for example for the surfaces of medical equipment for the ex vivo or in vivo treatment of organs, in the agri-food field, for example for the decontamination of fluids, etc.

Localized functionalization with various molecules according to the process of the invention can make it possible to carry out selective captures, on various regions of the substrate, of various molecules, from the viewpoint of their ability to interact with the various reaction units present on each of the functionalized regions.

Of course, any other known application for surfaces functionalized according to the invention can be envisioned.

The invention will now be described by means of the following examples and figures.

These examples are, of course, given by way of nonlimiting illustration of the invention.

### FIGURES

FIG. 1: diagrammatic representation of the four working regions defined using a Geneframe separator, of the surface of the substrates used in the examples.

FIG. 2: images obtained by detection of the fluorescence of the surfaces of a silicon oxide substrate functionalized according to example 1 in region No. 1 by silanization in an ionic liquid medium at 80° C., and of the reference substrate functionalized by silanization in toluene.

FIG. 3: images by detection of the fluorescence of the working regions No. 1 of the substrates prepared according to example 2, functionalized in region No. 1 by silanization at 80° C. in various ionic liquids.

FIG. 4: images by detection of the fluorescence of the substrates prepared according to example 3, functionalized in region No. 1 by silanization performed at room temperature (20° C.) in various ionic liquids.

FIG. 5: images by detection of the fluorescence of the working regions No. 1 of the substrates, prepared according to example 4, functionalized by silanization performed at a temperature of 20° C. or at 80° C., and for incubation times fixed at 2 hours or at 16 hours in toluene, which is the reference solvent, and in the ionic liquid [EMIM] [NTf₂] (L2).

FIG. 6: image by detection of the fluorescence of a substrate, prepared according to example 5, locally functionalized by silanization at room temperature in the ionic liquid [EMIM] [NTf₂] (L2).

FIG. 7: images by detection of the fluorescence of metal oxide substrates, functionalized according to example 6 by phosphation in a water/DMSO mixture (substrate 1) and in the ionic liquid [BMIM] [BF₄] (substrate 3).

### EXAMPLES

### Example 1

Comparison of the Functionalization by Silanization of a Silicon Oxide Substrate, in Ionic Liquid Medium at 80° C. and in Toluene Medium

i—Surface Functionalization of the Substrates

A process, in accordance with the invention, of silanization of a silicon oxide substrate in an ionic liquid is compared with a reference process of silanization in toluene, as described, for example, in patent No. FR 2 818 662.

Rehydration of the SiO₂ Substrate

Two silicon substrates (2.5 cm×2.5 cm), covered with a layer of oxide via thermal oxidation (thickness of 100 nm), are immersed for 30 minutes, with ultrasound, in an aqueous-alcoholic solution (40% water/60% EtOH v/v) of sodium hydroxide (0.1 M). After rinsing with deionized water, the substrates are dried under a nitrogen stream and then stoved at 80° C. for 15 minutes.

This rehydration step makes it possible to generate silanol functions at the surface of the substrate.

Functionalization by Silanization

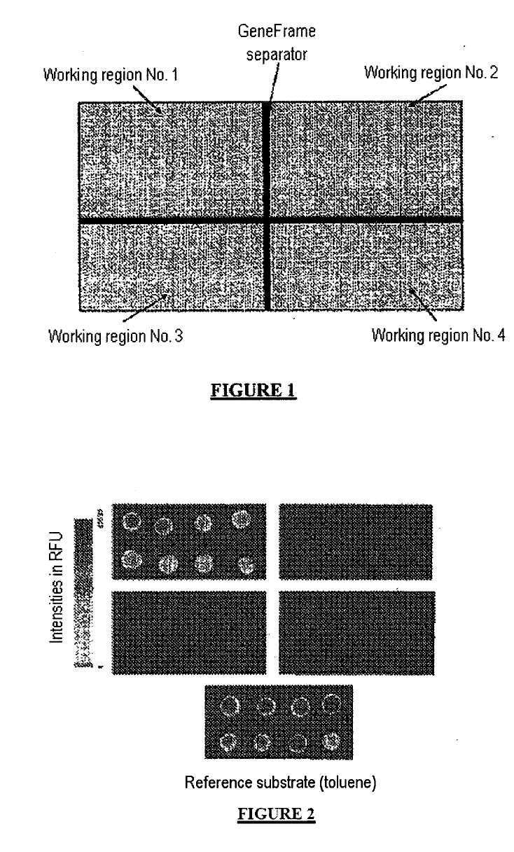

The first substrate thus rehydrated is separated into four distinct regions using a Geneframe separator thus defining four working regions, as represented in FIG. 1.

The second substrate is used as obtained after rehydration.

First Substrate

In the 1st working zone, a solution of 1-ethyl-3-methylimidazolium bis(trifluoromethane)sulfonamide [EMIM][NTf₂] ionic liquid containing 20 mM of reactive molecule 5,6-epoxyhexyltriethoxysilane is dispensed using a manual pipette; the region is then covered with a cover so as to create uniform spreading of the solution at the surface.

In the 2nd working region, a solution of 1-ethyl-3-methylimidazolium bis(trifluoromethane)sulfonamide [EMIM][NTf₂] ionic liquid containing 20 mM of 1,2-epoxy-5-hexene is dispensed and the region is covered with a cover.

In the 3rd region, only the ionic liquid is dispensed and the region is covered with a cover.

In the 4th region, no solution is dispensed.

Second Substrate

The second substrate, which serves as a reference, is completely immersed in a 20 mM solution of 5,6-epoxyhexyltriethoxysilane in toluene in the presence of triethylamine (0.05% by volume of the toluene).

The two substrates are then incubated at 80° C. for 15 hours. After incubation, the substrates are washed with a 95% ethanol solution and subjected to ultrasound for 15 minutes in an ethanol solution.

After drying under nitrogen, the substrates are placed in a stove heated at 110° C. for 3 hours.

ii—Characterization by Grafting of a Nucleic Acid

The functionalized substrates are compared by comparing the spots of hybridization between DNA fragments obtained after grafting of an oligonucleotide probe onto the function carried by the silanes, followed by hybridization with a target oligonucleotide carrying a fluorophore.

Modification of the Epoxide Functions Carried by the Silane Molecules Grafted onto the Substrates

The two substrates are immersed in a 0.2 M sulfuric acid solution for 2 hours with stirring in order to hydrolyze the epoxide function into diols, and then washed thoroughly with water and dried under a nitrogen stream.

The substrates are then incubated in an aqueous solution of sodium periodate (0.1 M) for 1 hour with stirring in order to obtain aldehyde functions.

Probe Immobilization

After thorough washing with deionized water and drying, a buffered solution of Na₂HPO₄ at 0.3 M containing amino oligonucleotides termed probes (5′NH₂-TTTTT GAT AAA CCC ACT CTA-3′) at the concentration of 10 μM is manually dispensed using a Gilson pipette in the form of spots (blocks of 4×4 spots) on the previously functionalized substrates. After incubation for 12 hours in the open air and at room temperature, the imine functions formed by reaction between the aldehyde and the amine are reduced by immersion of the substrates in an aqueous solution of sodium borohydride (0.1 M) for 1 hour. The substrates are then washed and dried under a nitrogen stream.

Detection by Fluorescence of the Oligonucleotide Probes

Hybridization with a Target Oligonucleotide Carrying a Fluorophore

A solution containing the fluorescent (CY3) complementary target in the commercial hybridization buffer “Hyb buffer” from Sigma Aldrich at a concentration of 0.1 μM is applied to the surface of the two substrates covered by a cover, and the whole assembly is then placed in a stove at 37° C. for 1 hour.

The two substrates are then washed with 0.2× sodium citrate buffer, and then dried before detection of the fluorescence (Genomic Solutions™ GeneTac™ LS IV (emission Cy3: 570 nm; excitation Cy3: 550 nm; in Relative Fluorescence Units (RFU)). Scan: 29%.

Results

The images obtained by detection of the fluorescence, presented in FIG. 2, below, show that the probes, and therefore the silane molecules, are grafted only in working region No. 1 and also on the reference substrate. Furthermore, the light intensities obtained are of the same order of magnitude in the case of the silanization in ionic liquid medium according to the process of the invention, and in toluene, which proves that the silanization is equally effective according to the two processes.

### Example 2

Functionalization by Silanization of a Silicon Oxide Substrate in Various Ionic Liquid Matrices at 80° C., and Characterization by Grafting of a Nucleic Acid

Other substrates functionalized according to a process in accordance with the invention were prepared, according to the protocol used for the first substrate described in previous example 1.

The ionic liquids used are the following:
L1: 1-butyl-1-methylpyrrolidinium bis(trifluoromethane)sulfonamide [BMP][NTf₂];
L4: trimethylbutylammonium bis(trifluoromethane)sulfonamide [TMBA][NTf₂];
L5: 1-butyl-3-methylimidazolium hexafluorophosphate [BMIM][PF₆];
L6: 1-butyl-3-methylimidazolium tetrafluoroborate [BMIM][BF₄] and
L7: 1-ethyl-3-methylimidazolium trifluoromethanesulfonate [EMIM][TfO].

The characterization of the functionalizations of the various substrates carried out is performed according to point ii- of example 1.

Results

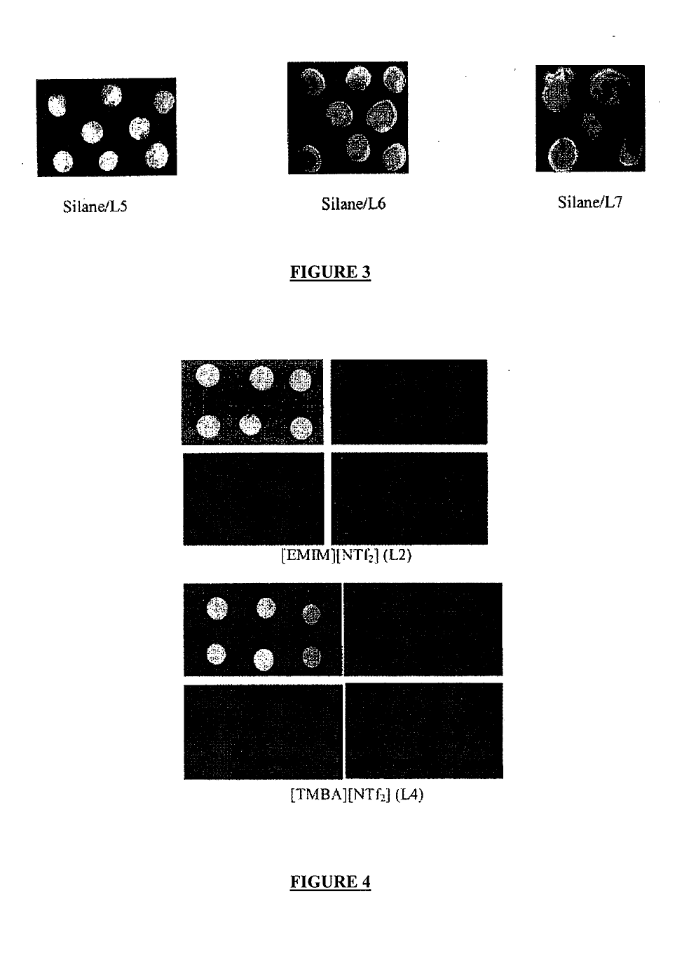

Some final images (i.e. images after hybridization and detection by fluorescence) of the working regions No. 1 of the substrates obtained are presented in FIG. 3 (scan: 29%).

All of the ionic liquids used in a process in accordance with the invention make it possible to obtain effective surface functionalization. It is noted that the intensity of the spots obtained is highest in the case of an ionic liquid comprising a 1-ethyl-3-methyl-imidazoliumcation.

### Example 3

Comparison of the Functionalization by Silanization of a Silicon oxide Substrate in Ionic Liquid Medium at Room Temperature and Toluene Medium

A process, in accordance with the invention, of silanization of as silicon oxide substrate in an ionic liquid is compared with a reference process of silanization in toluene, as described, for example, in patent No. FR 2 818 662.

The comparison of the two protocols is carried out according to the protocol implemented in point ii- of example 1.

The same silanization protocols of example 1 and the same ionic liquids of example 2 were used, other than the fact that the silanization reaction was performed at room temperature (20° C.), and not at 80° C.

The results obtained show that the probes are grafted only in the working regions No. 1 of the various substrates treated, and also on the reference substrate.

Furthermore, the light intensities are of the same order of magnitude in the case of the silanization in ionic liquid medium and in toluene, which proves that the silanization is equally effective according to the two processes.

These results show that silanization according to the process of the invention can be carried out both at 80° C. (examples 1 and 2) and at room temperature in the ionic liquids used.

It is noted that the intensity of the spots obtained is higher in the case of an ionic liquid comprising a 1-ethyl-3-methylimidazolium cation.

Some images obtained by detection of the fluorescence are presented in FIG. 4 below .

### Example 4

Evaluation of the Silanization Kinetics at Room Temperature and at 80° C.

The inventors evaluated the impact of the solvent medium used on the kinetics of the silanization reaction. The same protocols as those implemented in the previous examples were used, the silanization reaction being carried out either in toluene, which is the reference solvent, or in the ionic liquid ([EMIM][NTf₂] (L2)), at room temperature (20° C.) or at 80° C. The incubation times at 20° C. or at 80° C. are fixed at 2 hours or at 16 hours.

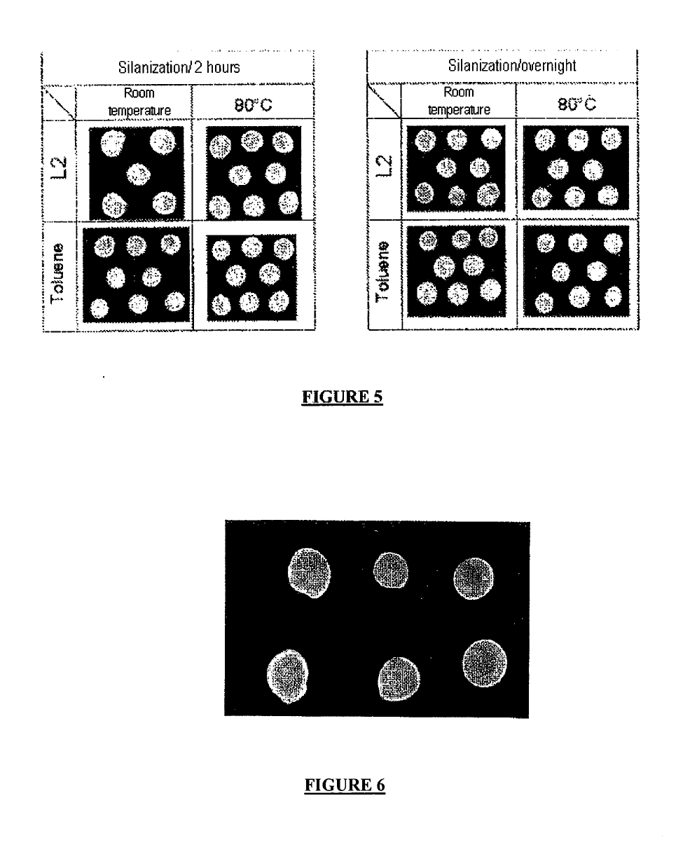

The results are presented in FIG. 5 below. The scans were carried out at a power of 29%.

No notable difference is observed for a functionalization carried out in toluene and that carried out according to the invention in the ionic liquid, between the various incubation times and at different temperatures.

### Example 5

Localized Functionalization of a Silicon Oxide Substrate in Ionic Liquid Medium, and Characterization by Grafting of a Nucleic Acid

i—Surface Functionalization of the Substrates

Rehydration of the SiO₂ Substrate

A silicon substrate (2.5 cm×2.5 cm) covered with a layer of thermal oxide (100 nm) is immersed for 30 minutes, with ultrasound, in an aqueous-alcoholic solution (40% water/60% EtOH v/v) of sodium hydroxide (0.1 M). After rinsing with deionized water, the substrate is dried under a nitrogen stream and then stoved at 80° C. for 15 minutes.

Functionalization by Silanization

A solution of 1-ethyl-3-methylimidazolium bis(trifluoromethane)sulfonamide [EMIM][NTf₂] ionic liquid (L2) containing 20 mM of 5,6-epoxyhexyltriethoxysilane is dispensed using a micropipette (0.6 μl) in the form of spots on the surface of the rehydrated substrate.

The substrate is then left for 15 hours at room temperature. The substrate is then washed with a 95% ethanol solution and subjected to ultrasound for 15 minutes in an ethanol solution. After drying under nitrogen, crosslinking is carried out by heating at 110° C. in a stove for 3 hours.

ii—Characterization by Grafting of a Nucleic Acid

Modification of the Epoxide Functions Carried by the Silane Molecules Grafted onto the Substrates

The substrate is then immersed in a 0.2 M sulfuric acid solution for 2 hours with stirring in order to hydrolyze the epoxide function to give diols, and then washed thoroughly with water and dried under a nitrogen stream.

The substrate is then incubated in an aqueous solution of sodium periodate (0.1 M) for 1 hour with stirring in order to obtain aldehyde functions.

Probe Immobilization

After thorough washing with deionized water and drying, a buffered solution of Na₂HPO₄ at 0.3 M containing amino oligonucleotides termed probes (5′NH₂-TTTTT GAT AAA CCC ACT CTA-3′) at the concentration of 10 μM is dispensed using a micropipette in the form of spots, on the same regions as those of the previous deposition of the solution L2/silane. After incubation for 12 hours in the open air and at room temperature, the imine functions formed by reaction between the aldehyde and the amine are reduced by immersion of the substrate in an aqueous solution of sodium borohydride (0.1 M) for 1 hour. The substrate is then washed and dried under a nitrogen stream.

Detection by Fluorescence of the Oligonucleotide Probes

Hybridization with an oligonucleotide carrying a fluorophore A solution containing the fluorescent (CY3) complementary target in the commercial hybridization buffer “Hyb buffer” from Sigma Aldrich at a concentration of 0.1 μM is applied to the entire surface of the substrate covered with a cover and the whole assembly is then placed in a stove at 37° C. for 1 hour. The substrate is then washed with 0.2× sodium citrate buffer and then dried before detection of the fluorescence (Genomic Solutions™ GeneTac™ LS IV (emission Cy3: 570 nm; excitation Cy3: 550 nm)). Scan: 29%.

Results

The image obtained by detection of the fluorescence presented in FIG. 6 shows that the probes, and therefore the silane molecules, have indeed been grafted locally in the regions of the deposit of the solution L2/silane.

### Example 6

Comparison of the Functionalization of a Metal Oxide (Indium Tin Oxide, ITO) Substrate by Grafting of a Phosphonic Acid, in Ionic Liquid Medium and in Water/Dimethyl Sulfoxide (DMSO) Medium

i—Surface Functionalization of the Substrates

In this example, the surface chemistry used to couple the probe molecule has a surface carboxylic acid function by virtue of the grafting of a phosphonic acid (6-phosphonohexanoic acid) at the surface of the ITO substrate. The step for immobilizing the probe molecule is carried out by means of the “peptide” coupling reaction between the surface carboxylic acid function and the amine function carried by the probe molecule.

ITO Substrate Rehydration

Four glass substrates (1 cm×1 cm), covered with a layer of ITO (thickness of 100 nm), are immersed for 30 minutes, with ultrasound, in an aqueous-alcoholic solution (40% water/60% EtOH v/v) of sodium hydroxide (0.1 M). After rinsing with deionized water, the substrates are dried under a nitrogen stream.

ITO Functionalization by Grafting of Ohosphonic Acid in Water/DMSO and Negative Control Thereof

The first substrate thus rehydrated is immersed in a solution of phosphonic acid (6-phosphonohexanoic acid) in a water/DMSO mixture (v/v:50/50) at the concentration of 5 mM.

The second substrate thus rehydrated is immersed in a water/DMSO mixture (v/v:50/50), acting as a negative control, since it is devoid of phosphonic acid.

ITO Functionalization by Grafting of Phosphonic Acid in an Ionic Liquid (L6: 1-butyl-3-methylimidazolium tetrafluoroborate [BMIM][BF₄]) and Negative Control Thereof

The third substrate thus rehydrated is covered, by means of a cover, with a solution of phosphonic acid (6-phosphonohexanoic acid) in the ionic liquid L6 at the concentration of 5 mM.

Finally, the fourth substrate thus rehydrated is covered, by means of a cover, with the ionic liquid L6, acting as a negative control, since it is devoid of phosphonic acid.

The four substrates are then left at room temperature for 15 hours. After incubation, the substrates are washed with a 95% ethanol solution and then with water, and subjected to ultrasound for 15 minutes in an ethanol solution.

ii—Characterization by Grafting of a Nucleic Acid

As previously, the functionalized substrates are compared by comparing the spots of hybridization between DNA fragments obtained after grafting of an oligonucleotide probe onto the function carried by the phosphonic acid, followed by hybridization with a target oligonucleotide carrying a fluorophore.

Probe Immobilization

A solution of amino oligonucleotides termed probes (5′NH₂-TTTTT GAT AAA CCC ACT CTA-3′) at the concentration of 10 μM in water in the presence of a peptide coupling agent (EPC: 1-ethyl-3-(3-dimethylaminopropyl)carbodiimide) is manually dispensed using a Gilson pipette in the form of spots (3 spots for the functionalized substrates and 2 for the negative controls) on the four substrates previously functionalized. After incubation for 2 hours at room temperature, the substrates are then washed with water and dried under a nitrogen stream.

Detection by Fluorescence of the Oligonucleotide Probes

Hybridization with a Target Oligonucleotide Carrying a Fluorophore

A solution containing the fluorescent (CY3) complementary target in the commercial hybridization buffer “Hyb buffer” from Sigma Aldrich at a concentration of 0.1 μM is applied to the surface of the four substrates covered with a cover and the whole assembly is then placed in a stove at 37° C. for 1 hour.

The substrates are then washed with 0.2× sodium citrate buffer, and then dried before detection of the fluorescence (Genomic Solutions™ GeneTac™ LS IV (emission Cy3: 570 nm; excitation Cy3: 550 nm; in Relative Fluorescence Units (RFU)). Scan: 42%.

Results

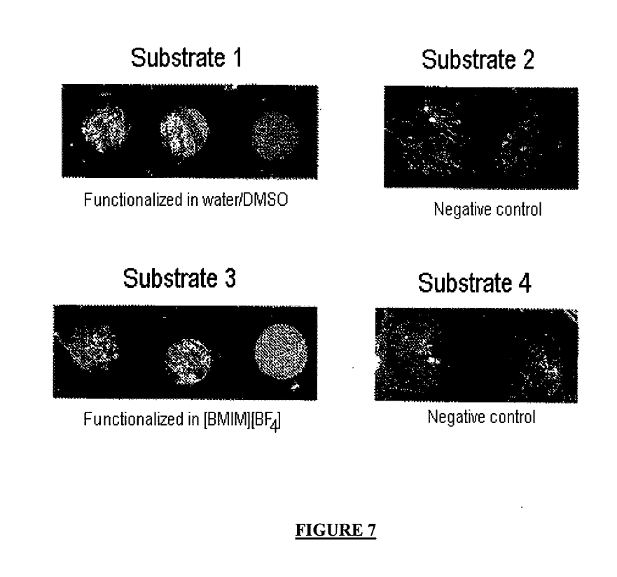

The images obtained by detection of the fluorescence, presented in FIG. 7 below, show that the probes, and therefore the phosphonic acid (6-phosphonohexanoic acid) molecules, have been grafted only onto substrates 1 and 3. Furthermore, the light intensities obtained on these two substrates are of the same order of magnitude in the case of the grafting of phosphonic acid in ionic liquid medium according to the process of the invention, and in the water/DMSO mixture, which proves that the grafting of the phosphonic acid onto the metal oxide surface is equally effective according to the two processes.

### REFERENCES

[1] J. Sagiv, Journal of the American Chemical Society, 1980, (102:1), 92-98.

[2] S. A. Paniagua et al., J. Phys. Chem C, 2008, 112, 7809-7817; H. Kim et al., Surface Science, 2008, 602, 2382-2388.

[3] Chapter 3 of “Ionic Liquids in Synthesis”, P. Wasserscheid and Tom Welton, Wiley, 2003.

[4] T. Welton, Chemical Review, 1999, 99, 2071-2083.

[5] M. J. Muldoon et al., Journal of the Chemical Society, 2001, 2, 433-435.

[6] J. F. Liu et al., Analytical Chemistry, 2003, 75, (21), 5870-5876.

[7] M. Mellah et al., Electrochemistry Communications, 2003, 5, (7), 591-593.

[8] P. Actis et al., 2008, 24, 6327-6333 ; J. Ghilane et al., Electrochemistry Communications, 2008, 1060-1063.

[9] C. Liang et al., J. Org. Chem., 2006, 586.

[10] M. H. Valkenberg et al., Green Chemistry, 2002, 4, 88-93.

[11] S. K. Nett et al., Macromol. Chem. Phys., 2009, 210, 971-976.

1.-20. (canceled)

21. A process for surface functionalization of a substrate, comprising:
(1) providing a substrate which has at least one surface comprising at least one hydroxyl function, and;
(2) bringing one or more point regions of the surface into contact with an ionic liquid matrix containing at least one molecule termed reactive, the molecule carrying at least one reactive function capable of interacting with at least one hydroxyl function of the surface, the bringing into contact with the ionic liquid matrix being carried out via the deposition of drops of the ionic liquid matrix, localized at the surface of each of the point regions;
wherein the bringing into contact is carried out under conditions favorable to the creation of a covalent bond between the reactive function of the molecule and a hydroxyl function of the surface.

22. The process of claim 21, wherein the reactive molecule also comprises at least one secondary reaction unit which is not reactive with respect to the hydroxyl function(s) of the surface and is not reactive with respect to the ionic liquid matrix.

23. The process of claim 21, wherein step (2) comprises, consecutively, (a) bringing one or more point regions of the surface into contact with an ionic liquid matrix devoid of reactive molecule, and (b) adding the reactive molecule(s) to the ionic liquid matrix.

24. The process of claim 21, wherein the mixture of an ionic liquid matrix devoid of reactive molecule and of the reactive molecule(s) is formed prior to the implementation of step (2).

25. The process of claim 21, wherein the bringing into contact with the ionic liquid matrix in step (2) is carried out via the deposition of drops of the ionic liquid matrix having a volume of less than 20 μl, localized at the surface of each of the point regions.

26. The process of claim 21, wherein step (2) uses two distinct reactive molecules formulated, respectively, in two distinct ionic matrices, each of the two matrices being deposited in the form of drops at the surface of at least two distinct point regions of the surface.

27. The process of claim 21, wherein the surface is an inorganic surface.

28. The process of claim 27, wherein the surface is of silicon oxide or of metal oxide.

29. The process of claim 21, wherein the substrate is an inorganic substrate.

30. The process of claim 29, wherein the substrate is a metal oxide or silicon oxide substrate.

31. The process of claim 21, wherein the surface is an organic surface.

32. The process of claim 31, wherein the surface is of organic polymer type.

33. The process of claim 21, wherein the hydroxyl function(s) is (are) naturally present on the surface, or generated prior to step (1) by means of one or more step(s) for treating the surface of the substrate.

34. The process of claim 21, wherein the interaction between the reactive function of the reactive molecule and a hydroxyl function of the surface is a silanization or phosphation reaction.

35. The process of claim 21, wherein the reactive function of the reactive molecule is represented by a group of formula:
(R₁R₂R₃)Si—
in which R₁, R₂ and R₃ are chosen, independently of one another, from halogen atoms, linear or branched C₁ to C₄ alkoxy groups and linear or branched C₁ to C₄ alkyl groups, with at least one of R₁, R₂ and R₃ being a halogen atom or a linear or branched C₁ to C₄ alkoxy group;
or of formula:
(R₄)(R₅)P(O)—
in which:
R₄ and R₅ are chosen, independently of one another, from linear or branched C₁ to C₄ alkoxy groups; or
R₄ and R₅ both represent a hydroxyl group; or
R₄ and R₅ both represent an —O⁻M⁺ group, in which M represents sodium, potassium or an ammonium group.

36. The process of claim 21, wherein the reactive molecule(s) is (are) chosen from the silane derivatives of formula (I) below:
(R₁R₂R₃)Si—R—(F) (I),
in which:
R₁, R₂ and R₃ are chosen, independently of one another, from halogen atoms, linear or branched C₁ to C₄ alkoxy groups and linear or branched C₁ to C₄ alkyl groups, with at least one of R₁, R₂ and R₃ being a halogen atom or a linear or branched C₁ to C₄ alkoxy group;
R is a linear or branched alkyl chain having from 1 to 100 carbon atoms, optionally comprising one or more heteroatoms and optionally one or more aryl groups; and
F is a chemical function which is inert with respect to the ionic liquid matrix and to the hydroxyl function(s) of the surface, and capable of interacting or reacting with a chemical, biochemical or biological molecule, it being possible for F to optionally be protected with a labile protective group.

37. The process of claim 36, wherein F is chosen from electrophilic chemical functions, nucleophilic chemical functions and inert chemical functions.

38. The process of claim 21, wherein the reactive molecule(s) is (are) chosen from the phosphonic acid derivatives of formula (II) below:
(R₄)(R₅)P(O)—R—F (II),
in which:
R₄ and R₅ are chosen, independently of one another, from linear or branched C₁ to C₄ alkoxy groups; or
R₄ and R₅ both represent a hydroxyl group; or
R₄ and R₅ both represent an —O⁻M⁺ group, in which M represents sodium, potassium or an ammonium group;
R is a linear or branched alkyl chain having from 1 to 100 carbon atoms, optionally comprising one or more heteroatoms and optionally one or more aryl groups; and
F is a chemical function which is inert with respect to the ionic liquid matrix and to the hydroxyl function(s) of the surface, and capable of interacting or reacting with a chemical, biochemical or biological molecule, it being possible for F to optionally be protected with a labile protective group.

39. The process of claim 38, wherein F is an electrophilic chemical function, nucleophilic chemical function, or inert chemical function.

40. The process of claim 21, wherein the ionic liquid matrix comprises one or more ionic liquid(s) of which the cation is imidazolium, pyrrolidinium, ammonium, pyridinium, phosphonium, or a sulfonium cation.

41. The process of claim 40, wherein the anion of the ionic liquid(s) is from bis(trifluoromethane)sulfonamide, hexafluorophosphate, tetrafluoroborate, or a trifluoromethanesulfonate anion.

42. The process of claim 21, wherein the ionic liquid matrix comprises one or more ionic liquid(s) chosen from:
1-ethyl-3-methylimidazolium bis(trifluoromethane)sulfonamide [EMIM][NTf₂];
1-butyl-1-methylpyrrolidinium bis(trifluoromethane)sulfonamide [BMP][NTf₂];
trimethylbutylammonium bis(trifluoromethane)sulfonamide [TMBA][NTf₂];
1-butyl-3-methylimidazolium hexafluorophosphate [BMIM][PF₆];
1-butyl-3-methylimidazolium tetrafluoroborate [BMIM][BF₄]; and
1-ethyl-3-methylimidazolium trifluoromethanesulfonate [EMIM][TfO].

43. The process of claim 21, wherein step (2) is carried out at room temperature.

44. The process of claim 21, wherein the interaction in step (2) between the reactive function of the reactive molecule and a hydroxyl function of the surface is thermally, photochemically, electrochemically or biochemically assisted.

45. The process of claim 44, wherein the interaction in step (2) between the reactive function of the reactive molecule and a hydroxyl function of the surface is thermally assisted by microwaves.

46. The process of claim 44, wherein the interaction in step (2) between the reactive function of the reactive molecule and a hydroxyl function of the surface is thermally assisted by exposure of the treated surface to a temperature of greater than or equal to 20° C.

47. The process of claim 21, comprising, following step (2), at least one step of removing the ionic liquid matrix, of washing the functionalized surface and/or of drying the functionalized surface.


SEQUENCE LISTING (1 sequence)

SEQ ID NO: 1 - DNA, 20 bp, Artificial Sequence
  Synthetic Primer
tttttgataaacccactcta